(19) United States
(12) Patent Application Publication
(10) Pub. No.: US 2004/0064753 A1
(43) Pub. Date: Apr. 1, 2004

(54) Apparatus for controlling in-system programming

(75) Inventor: Chi-Pei Wang, Taichung (TW)

Correspondence Address: TROXELL LAW OFFICE, PLLC, SUITE 1404, 5205 LEESBURG PIKE, FALLS CHURCH, VA, 22041, US

(73) Assignee: ENE Technology Inc.

(21) Appl. No.: 10/419,826

(22) Filed: Apr. 22, 2003

(30) Foreign Application Priority Data
Sep. 26, 2002 (TW) 091122223

(51) Int. Cl. H04L 1/22

(52) U.S. Cl. 714/3

(57) ABSTRACT

A apparatus for controlling in-system programming for repairing a malfunctioned programmable element in an electronic device without disassembling the casing or replacing a new element chip includes an apparatus equipped with an in-system programming chip to connect the programmable element that has faulty program codes or data to another normal computer. By means of the apparatus of the invention, the program codes or data on the programmable element may be reprogrammed to fix the problems or defects of the programs to resume normal operation, and to speed up repairs and reduce waste of manpower.

### BACKGROUND OF THE INVENTION

1. Field of the Invention

The invention relates to a apparatus for controlling in-system programming that repairs a malfunctioned electronic device by restoring codes through a normal electronic device equipped with in-system programming functions.

2. Description of the Prior Art

With continuous technology advance and innovations, electronic circuits have evolved from vacuum tubes in the past to semiconductor manufacturing processes of 0.18 μm and 0.13 μm at present. This not only creates a great challenge to people engaged in research and development, also brings huge and radical impact to people's life. How to find out a worthy target and niche in a constrained environment has become a great concern to many people working in the R & D area.

These days, consumer electronic products have been widely used by the general public. Through simple commands, life quality and work efficiency can be improved greatly. These electronic products include computers, Personal Digital Assistants (PDAs), mobile phones, and the like. They not only have changed people's life in the modem society, also have improved working quality and efficiency.

While the electronic devices provide great conveniences to people, they must function properly to become useful. Once problems occur or they cannot operate properly, a great loss might ensue. The consequences could be even more severe than when they were not being used in the first place. Hence nowadays almost all enterprises demand warranty and services from the vendors of electronic devices to ensure that the electronic devices being used function correctly without errors to avoid possible losses.

A general electronic product that contains a microprocessor usually needs some modifications of program codes in the microprocessor after shipped. This is because a product rarely is perfect or error-free during the development period. This is especially true for complex products such as notebook computers. As market timing is very important, some products need firmware upgrades even at the initial marketing stage. The general firmware upgrade is accomplished during machine operation. Conventional techniques for in-system programming is to rewrite the program codes on the chip that has built-in in system programming capability. In the event that the whole system cannot be started normally, the firmware chip must be removed, and a burner has to be used to write a programmable element. Such an approach takes long transportation time. It causes a great inconvenience to the enterprises that use the electronic devices. Through the apparatus of in-system programming of the invention, a chip equipped with built-in in-system programming capability can perform rewriting operation on another programmable chip without removing the chip. The re-programming process for the dysfunctional device can be accomplished by using a normal computer with a few connecting signal lines.

### SUMMARY OF THE INVENTION

In view of the aforesaid disadvantages occurred to conventional techniques, the object of the invention is to provide a apparatus for controlling in-system programming that can repair a malfunctioned electronic device without removing soldered chips from the circuit board thereby to improve service quality of vendors and enhance customer confidence. The invention connects a malfunctioned electronic device to another electronic device without undoing the soldering of the chips from the circuit board and through connecting to a normal operating electronic device to repair and restore the malfunctioned electronic device thereby to speed up repairing task and reduce repairing workloads.

Another object of the invention is to execute the in-programming process for the programmable element in the malfunctioned electronic device through a programming controller in a second electronic device that has a programming unit in the system to repair and restore the programming problems. Moreover, the programming controller in the system also processes signal conversion for the serial interfaces and parallel interfaces of various units to detect whether execution has been successfully completed.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the embodiment of the invention showing the connected electronic devices.

FIG. 2 is a block diagram of the internal structure of an in-system programming unit of the embodiment of the invention.

FIG. 3 is a block diagram of the connecting condition for in-system programming of the embodiment of the invention.

FIG. 4 is a flow chart of the in-programming process of the embodiment of the invention.

### DESCRIPTION OF THE PREFERRED EMBODIMENT

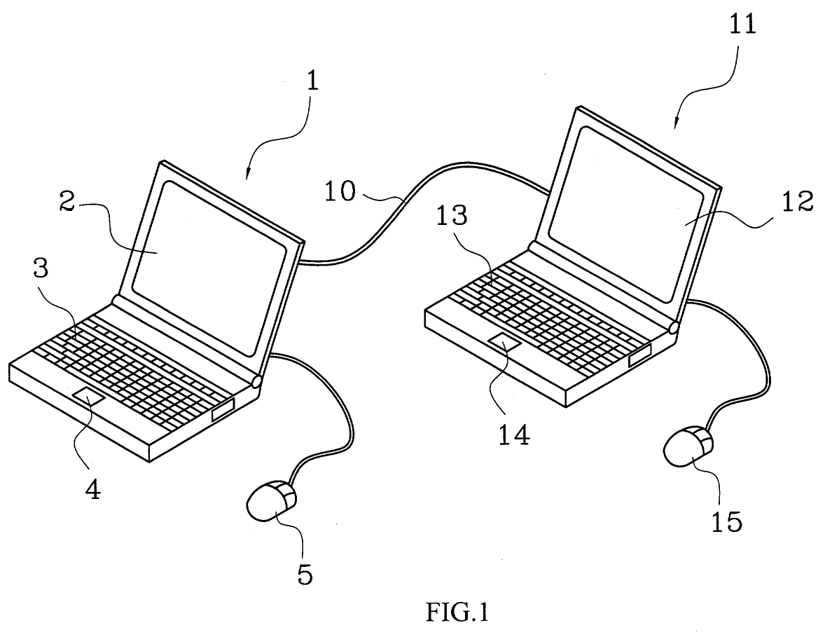

Refer to FIG. 1 for an embodiment of the invention that has electronic devices connecting together. When an electronic device malfunctions, there is no need to undo the soldering to remove the chip from the circuit board. In stead, it may be connected to an another normal electronic device through a transmission line 10, and through the system of the normal electronic device to execute and complete the repair process. It includes a first electronic device 1 and a second electronic device 11 connecting by a transmission line 10. The first electronic device 1 has a first screen 2, a first input device 3, a first input board 4 and a first controlling device 5. Similarly, The second electronic device 11 has a second screen 12, a second input device 13, a second input board 14 and a second controlling device 15. When a programmable element in the second electronic device 11 malfunctions and does not work properly, through the connection set forth above, programming process may be controlled and executed from the first electronic device 1 to rewrite program codes on the defected programmable element in the second electronic device 11.

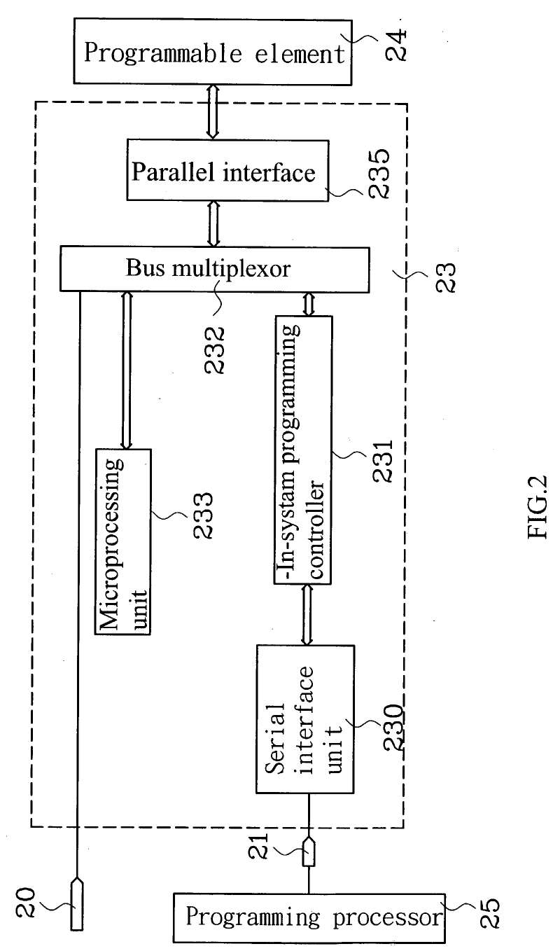

Refer to FIG. 2 for the structure of the in-programming unit of the embodiment of the invention. A built-in programming unit micro controller 23 is located in the second electronic device 11. When the second electronic device malfunctions, it may be connected to the first electronic device 1 to process programming tasks. The built-in programming unit micro controller 23 of the second electronic device 11 includes a serial interface unit 230, an in-system programming controller 231, a bus multiplexor 232, a microprocessing unit 233 and a parallel interface 235 connecting to a programmable element 24.

When there is a need to update the program codes of the programmable element 24 of the second electronic device 11, first, generate a programming enabling signal 20 and maintain the programming enabling signal 20 at the enabling level when the transmission line 10 is connected. The programming enabling signal 20 switches the control, address and data signals of the programmable element 24. When the system is in a non-programmable condition, the normal microprocessing unit 233 of the second electronic device 11 is in control, and the in-system programming controller 231 controls the programmable element 24 through the bus multiplexor 232 in the programming enabling condition, this bus multiplexor located in the built-in programming unit micro controller for switching and controlling a control bus of the programmable element and the microprocessing unit through a programming enabling signal. As shown in the drawing, a serial signal 21 transmits or receives interim register value of the serial interface unit 230 that includes address interim register and data interim register of the programmable element 24, and interim register signals such as the control interim register value of the in-system programming controller 231. The serial interface unit 230 further receives or transmits data of a programming processor 25 outside the built-in programming unit micro controller 23. The programming processor 25 is a computer processor to execute the programming programs. In the embodiment of the invention, it is the programming data of the first electronic device 1. The data are transmitted through the serial signal 21 to the built-in programming unit micro controller 23, and include data of the address interim register and the data interim register required by the programmable element 24, and data of the control interim register of the in-system programming controller 231. During reading or writing the data interim register, the in-system programming controller 231 outputs the address value previously received from the serial signal 21 and stored in the address interim register through a parallel interface 235 to the address line of the programmable element 24. In the mean time, outputs control signals of the programmable element 24. During output of the control signals and address signals, if data interim register of the serial interface unit 230 is read, data value is transmitted through the in-system programming controller 231 which receives data bus and transmits to the serial interface unit 230, then is transmitted back to the programming processor 25. During output of the control signals and address signals, if data interim register of the serial interface unit 230 is written, and meanwhile the in-system programming controller 231 receives data interim register of the serial interface unit 230, the value of the data interim register is output to the data bus of the programmable element 24 to complete writing actions of the programmable element. All of signals output from the in-system programming controller 231 are enabling signals which are selectively output to the programmable element 24. In other words, during the programming process, control signals of the programmable element 24 are directly output from the in-system programming controller 231.

When activating the in-system programming process, the connection of the microprocessing unit 233 and the system is switched by the programming enabling signal 20 to the in-system programming controller 231 which takes over the control, at that moment the microprocessing unit 233 does not operate. There is a ground signal to enable the two electronic device systems to have the same voltage level so that signal transmission between the first electronic device 1 and the second electronic device 11 may be normal. The connecting signals in the system include serial signals and ground signals. Above discussion relates to the connection relationship of various units of the in-programming unit of the invention shown in FIG. 2.

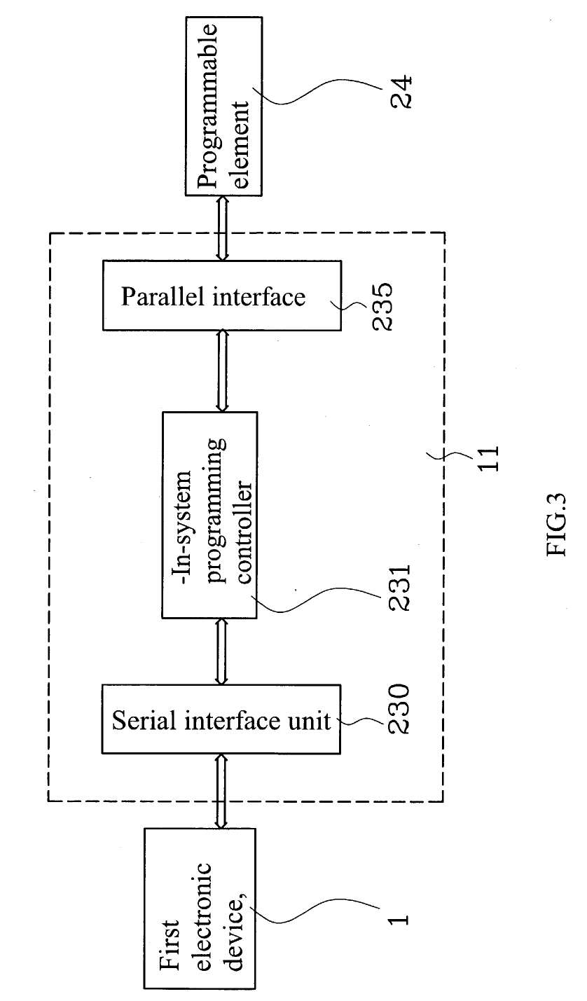

Refer to FIG. 3 for connecting condition of the in-system programming of the embodiment of the invention. The first electronic device 1 in the embodiment shown in FIG. 1 becomes the main processing device in FIG. 3. The second electronic device 11 connects to the first electronic device 1 through a serial interface unit 230, and is contained in the built-in programming unit micro controller 23 of the second electronic device 11 with the in-system programming controller 231, and connects to the programmable element 24 through a parallel interface 23. The serial interface unit 230 used in this embodiment is the transmission line 10 shown in FIG. 1. In practice, there is no restriction for the type of the serial interface and the parallel interface bus. The first electronic device 1 operates through the programs described in FIG. 2. It connects to the in-system programming controller 231 of the built-in programming unit micro controller 23 of the second electronic device 11 through the serial interface 230, and through the parallel interface 235 to access the programmable element 24 to achieve the object of programming of the embodiment of the invention.

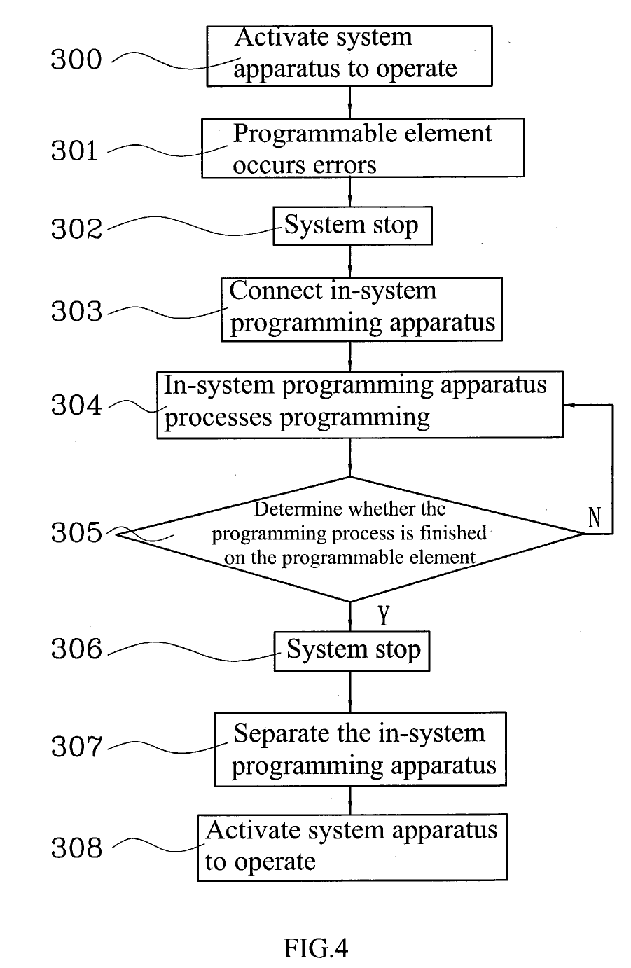

Refer to FIG. 4 for the in-programming process of the embodiment of the invention. After the system apparatus is activated and operates 300; the second electronic device 11 starts operation; once the second electronic device 11 has problems on internal elements, i.e. erroneous operations 301 occur to the programmable element, the programmable element 24 in the second electronic device 11 has defects on the program codes or data and the second electronic device 11 operates abnormally, the system stops operation 302, and the second electronic device 11 is shut down; then connect in-system programming apparatus 303, i.e. connect the first electronic device 1 to the second electronic device 11 through a transmission line 10; next, execute programming process 304 through the in-system programming apparatus, i.e. through the first electronic device 1 to process re-programming operation for the erroneous programmable element 24 of the second electronic device 11; the first electronic device 1 further determines whether programming operation for the programmable element 24 is finished 305; if negative, restart or repeat the programming process through the first electronic device 1; if positive, the programming process completed, and the system stops operation 306; then the programming apparatus is separated 307; the transmission line between the first electronic device 1 and the second electronic device 11 is removed; then the system apparatus is restarted for operation 308, i.e. the second electronic device 11 restarts for operation.

By means of the control apparatus set forth above, the in-system programming controller can execute programming process for the programmable element in the malfunctioned electronic device, and repair the program problems of system execution.

While the preferred embodiment of the invention has been set forth for the purpose of disclosure, modifications of the disclosed embodiment of the invention as well as other embodiment thereof may occur to those skilled in the art. Accordingly, the appended claims are intended to cover all embodiments which do not depart from the spirit and scope of the invention.

I claim:

1. An apparatus for controlling in-system programming by connecting a first electronic device to a second electronic device through a transmission line to process programming repair operations, comprising:
a built-in programming unit micro controller located in the second electronic device to allow the first electronic device to execute programming operations to the second electronic device;
a serial interface unit located in the built-in programming unit micro controller for transmitting and receiving a serial signal from the first electronic device, and connecting the first electronic device to the built-in programming unit micro controller;
an in-system programming controller located in the built-in programming unit micro controller for receiving the serial signal transmitted from the serial interface unit;
a programmable element being a programmable chip and being connected to the built-in programming unit micro controller through a parallel interface; and
a bus multiplexor located in the built-in programming unit micro controller for switching and controlling a control bus of the programmable element and a microprocessing unit through a programming enabling signal.

2. The apparatus for controlling in-system programming of claim 1, wherein the serial interface unit, the in-system programming controller and the parallel interface are located in the second electronic device.

3. The apparatus for controlling in-system programming of claim 1, wherein the serial interface unit is the transmission line connecting the first electronic device to the second electronic device.

4. The apparatus for controlling in-system programming of claim 1, wherein the serial signal includes signals of an address interim register of the serial interface unit, a data interim register and a control interim register of the in-system programming controller.

5. The apparatus for controlling in-system programming of claim 4, wherein the interim register is a memory for data writing and reading, wherein the data include address and data of the programmable element and control signals of the control interim register of the in-system programming controller.
